(19) United States
(12) Patent Application Publication
(10) Pub. No.: US 2012/0014629 A1
(43) Pub. Date: Jan. 19, 2012

(54) Porous hydrodynamic bearing

(75) Inventors: Young Tae Kim, Seoul (KR); Ta Kyoung Lee, Hwaseong (KR)

(73) Assignee: SAMSUNG ELECTRO-MECHANICS CO., LTD, Suwon (KR)

(21) Appl. No.: 13/137,026

(22) Filed: Jul. 15, 2011

(30) Foreign Application Priority Data
Jul. 16, 2010 (KR) 10-2010-0069187
Jun. 8, 2011 (KR) 10-2011-0055171

(51) Int. Cl. F16C 32/06; B23H 3/00

(52) U.S. Cl. 384/100; 205/640

(57) ABSTRACT

There is provided a porous hydrodynamic bearing including a sleeve supporting a shaft, wherein the sleeve is formed of a sintered body containing at least one metal powder selected from a group consisting of SUS 304, SUS 430, and iron (Fe). In the sleeve formed of the sintered body containing at least one metal powder selected from the group consisting of SUS 304, SUS 430, and iron (Fe), surface pores and inner pores are not in communication with each other, whereby a leakage phenomenon of dynamic pressure may be reduced, as compared to a sleeve made of an alloy of Cu and Fe in which opened pores are formed.

### CROSS-REFERENCE TO RELATED APPLICATIONS

This application claims the priority of Korean Patent Application No. 10-2010-0069187 filed on Jul. 16, 2010, and Korean Patent Application No. 10-2011-0055171 filed on Jun. 8, 2011, in the Korean Intellectual Property Office, the disclosure of which is incorporated herein by reference.

### BACKGROUND OF THE INVENTION

1. Field of the Invention

The present invention relates to a porous hydrodynamic bearing, and more particularly, to a hydrodynamic bearing in which a sleeve supporting a shaft of a spindle motor is formed of a steel use stainless (SUS) series or iron (Fe) powder sintered body and pores formed in the sleeve are closed pores.

2. Description of the Related Art

As a method of molding a groove so as to generate dynamic pressure is generated in a sleeve supporting a shaft of a spindle motor, a method of machining a material to have a desired shape and dimension through cutting machining and then forming a groove in an inner diameter thereof through ball rolling or a method of forming a sleeve itself through sintering pressing and forming a groove through the same shaping molding process is used.

In addition, the groove may be formed by performing general machining such as cutting machining, or the like, or performing electrolytic machining (ECM) on the sintering pressed sleeve.

The sintering pressed sleeve is slightly lower in view of a product feature, as compared to other existing machining methods; however, it requires significantly lower manufacturing costs. Further, in the case of the sintering pressed sleeve, an oil escape groove may not be freely formed in an exterior of the sleeve.

A sintered sleeve according to the related art is mainly made of a mixture of Cu and Fe. In this case, the sintered sleeve mainly made of a mixture of Cu and Fe has high air permeability and includes opened pores, such that oil may flow therein.

The sintered sleeve made of the mixture of Cu and Fe is immersed in a resin, such that the pores thereof are filled with the resin, thereby supplementing dynamic pressure.

Research into and development of a sintered sleeve that does not need to unnecessarily fill pores or supplement dynamic pressure lost due to, the pores by changing the material characteristics of the sintered sleeve have been demanded.

### SUMMARY OF THE INVENTION

An aspect of the present invention provides a hydrodynamic bearing in which a sleeve supporting a shaft of a spindle motor is formed of a steel use stainless (SUS) series or iron (Fe) powder sintered body and pores formed in the sleeve are closed pores.

According to an aspect of the present invention, there is provided a porous hydrodynamic bearing including a sleeve supporting a shaft, the sleeve being formed of a sintered body containing at least one metal powder selected from a group consisting of steel use stainless (SUS) series including SUS 304, SUS 430 or the like, and iron (Fe).

The sleeve may include a hydrodynamic groove formed through a sintering process and has surface porosity of 20 to 50%.

The hydrodynamic groove may be formed through electrolytic machining.

The sleeve may include a groove formed through electrolytic machining.

The sintered body may have an oil content ratio of 6 to 20%.

The SUS 304 may include 100 parts by weight of iron (Fe), 11 to 28 parts by weight of nickel (Ni), and 16 to 38 parts by weight of chrome (Cr).

The SUS 304 may further include at least one impurity selected from a group consisting of carbon (C), oxygen (O), silicon (Si), manganese (Mn), phosphorus (P), and sulfur (S).

The pores formed in the sleeve may be closed pores keeping oil from flowing between one surface and the other surface of the sleeve in the diameter direction thereof.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of a porous hydrodynamic bearing and a partially enlarged view of a sleeve according to an embodiment of the present invention;

FIG. 2 is a photograph of a surface of the porous hydrodynamic bearing according to an embodiment of the present invention photographed by a scanning electron microscope (SEM); and

FIG. 3 is a graph illustrating stress-strain curves of Inventive Examples and Comparative Example according to the present invention.

### DETAILED DESCRIPTION OF THE PREFERRED EMBODIMENT

Embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are construed as being included in the spirit of the present invention.

Further, throughout the drawings, the same or similar reference numerals will be used to designate the same or like components having the same functions in the scope of a similar idea.

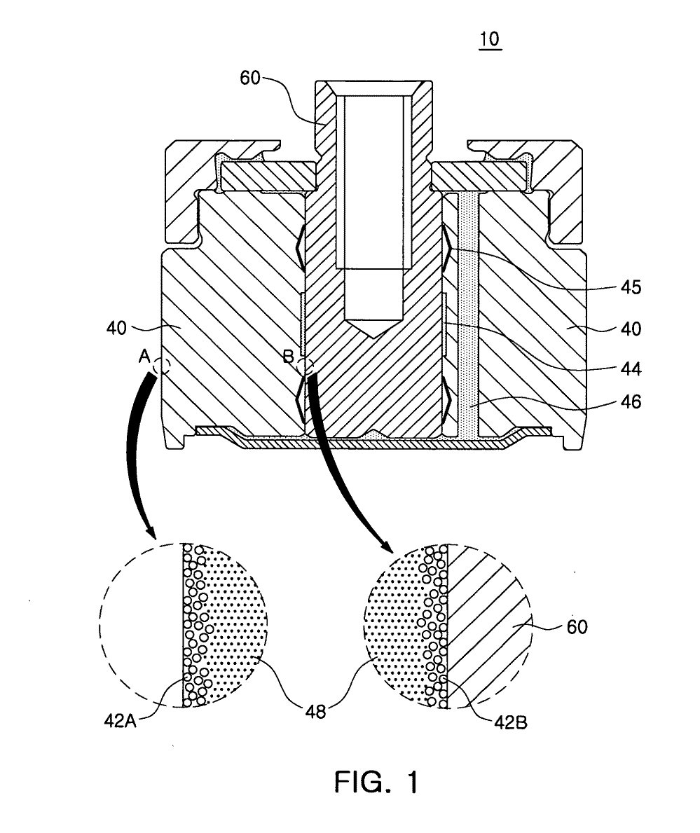

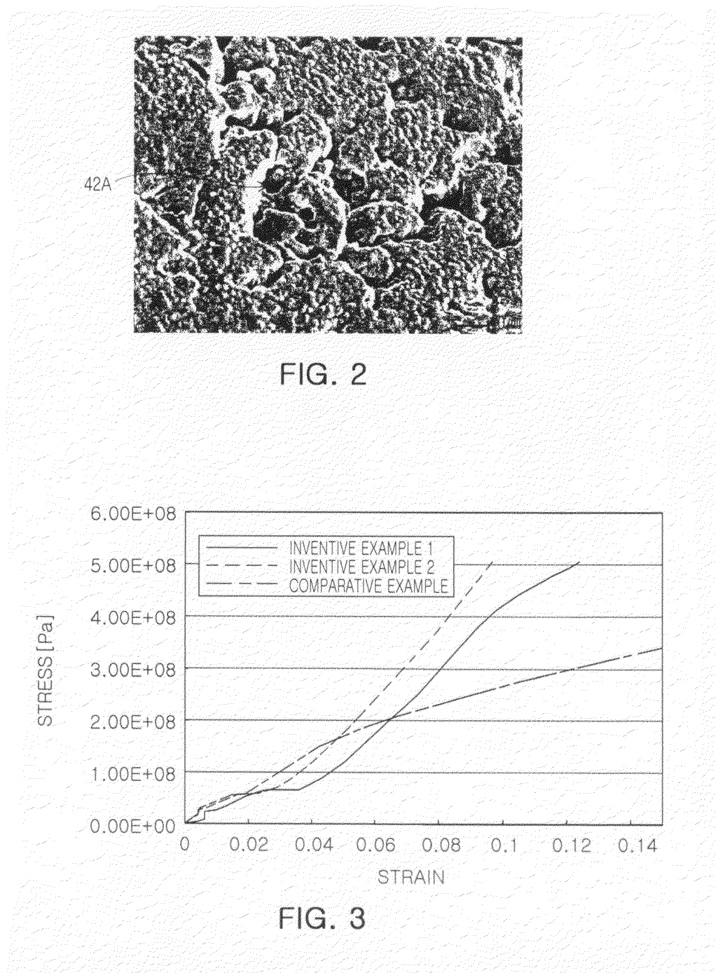

FIG. 1 is a cross-sectional view of a porous hydrodynamic bearing and a partially enlarged view of a sleeve according to an embodiment of the present invention. FIG. 2 is a photograph of a surface of the porous hydrodynamic bearing according to an embodiment of the present invention photographed by a scanning electron microscope (SEM).

Referring to FIGS. 1 and 2, a porous hydrodynamic bearing 10 according to the present embodiment may include a sleeve 40 supporting a shaft 60.

The sleeve 40 is formed of a steel use stainless (SUS) series or iron (Fe) powder sintered body. The SUS series or iron (Fe) powder sintered body may contain at least one metal powder selected from a group consisting of SUS 304, SUS 430, iron (Fe), or the like.

The sleeve 40 includes a hydrodynamic groove 45 formed in an inner peripheral surface thereof in order to generate dynamic pressure. The hydrodynamic groove 45 may be formed through electrolytic machining.

The sleeve 40 and the shaft 60 include oil 46 filled in a minute clearance therebetween, such that when the shaft 60 rotates at high speed, an oil film is formed between the sleeve 40 and the shaft 60, thereby allowing the shaft 60 to rotate smoothly.

In addition, the sleeve 40 includes the hydrodynamic groove 45 formed therein to thereby increase pressure within the bearing.

Therefore, a phenomenon in which the pressure within the hydrodynamic bearing 10 becomes negative pressure may be prevented.

The hydrodynamic groove 45 may be formed through electrolytic machining. In addition, the sleeve 40 may include escape grooves 44 or various grooves formed through electrolytic machining.

When the sleeve 40 is made of the SUS series material, surface pores at outer surfaces 42A and 42B of the sleeve 40 have a size significantly larger than inner pores 48.

Therefore, the inner pores 48 have an inner porosity keeping oil from flowing between one surface 42A and the other surface 42B of the sleeve 40 in a diameter direction thereof.

That is, the inner pores 48 formed in the sleeve 40 may be closed pores keeping the oil from flowing between one surface 42A and the other surface 42B of the sleeve 40 in the diameter direction thereof.

In other words, the sleeve 40 in which the pores formed therein are closed pores serves as the hydrodynamic bearing 10 capable of supporting the shaft 60.

The bearing 10 in which the sleeve is formed of the SUS series or iron (Fe) powder sintered body and the pores formed in the sleeve are the closed pores as described above may minimize leakage of dynamic pressure, as compared to the sintered sleeve made of an alloy of Cu and Fe.

The SUS 304 may contain 100 parts by weight of iron (Fe), 11 to 28 parts by weight of nickel (Ni) , and 16 to 38 parts by weight of chrome (Cr).

In addition, the SUS 304 may further contain at least one impurity selected from a group consisting of carbon (C), oxygen (O), silicon (Si), manganese (Mn), phosphorus (P), and sulfur (S).

The SUS 304 has properties such as a yield point of 175 kg_{f}/mm², a tensile strength of 480 kg_{f}/mm², and an elongation of 40%.

FIG. 2 is a photograph of a surface of the porous hydrodynamic bearing photographed by a scanning electron microscope, in which the porous hydrodynamic bearing includes the sleeve formed of the SUS series or iron (Fe) powder sintered body containing the above-mentioned components.

In this case, a pore size may not be reduced to 20% or less due to characteristics of a SUS series or iron (Fe) material, and surface porosity may be higher than that of the sleeve made of the mixture of Cu and Fe according to the related art by about 5 to 25%.

In addition, when the surface porosity is 50% or more, a phenomenon in which a mean deviation of dynamic pressure increases is caused. Therefore, in order to reduce dynamic pressure loss, a minute clearance between the sleeve and shaft needs to be reduced. In this case, it is significantly difficult to perform management in view of assembly.

Meanwhile, in the case of the bearing including the sleeve formed of the SUS series or iron (Fe) powder sintered body manufactured according to an embodiment of the present invention, even though surface porosity is high, the inner pores have air permeability low enough to be defined as closed pores.

Since it is difficult to directly measure air permeability, the air permeability may be inferred from an oil impregnation ratio. In this situation, in the case of the sleeve made of Cu and Fe according to the related art, when the surface porosity is 12%, the oil impregnation ratio is about 8 to 10%. On the other hand, in the case of the sleeve 40 according to the embodiment of the present invention, even when the surface porosity is 30% or more, the oil impregnation ratio is about 10 to 12%.

When the surface porosities are compared with each other, the oil is hardly impregnated in the sleeve 40 according to the present embodiment.

That is, the inner pores may be defined as closed pores.

Here, an opened pore means a surface pore, and a closed pore means an inner pore of the sleeve, which may keep the oil from flowing between one surface and the other surface of the sleeve in the diameter direction thereof.

Hereinafter, although the present invention will be described in detail with reference to Comparative Example and Inventive Examples, the present invention is not limited thereto.

In order to describe an effect of minimizing leakage of dynamic pressure of the porous hydrodynamic bearing according to an embodiment of the present invention, sleeves were manufactured according to Inventive Examples 1 and 2 and Comparative Example having physical properties as shown in the following Table 1.

In the Inventive Example 1, the sleeve formed of a SUS powder sintered body containing SUS 304 was used. In the Inventive Example 1, the sleeve formed of a SUS powder SUS powder sintered body containing SUS 430 was used. In the Comparative Example, the sleeve formed of a sintered body containing an alloy of Cu and Fe.

TABLE 1

| Physical | Comparative | Inventive | Inventive |
|---|---|---|---|
| Properties | Example | Example 1 | Example 2 |
| Oil Content | 5~9 | 6~10 | — |
| Ratio (%) | | | |
| Surface | 10~20 | 20~50 | — |
| Porosity (%) | | | |
| Compression | 6.8 | 6.4 | 6.2 |
| Density | | | |
| (g/cm³) | | | |
| Coefficient | 12.1 | 12.4 | 14.1 |
| of Thermal | | | |
| Expansion | | | |
| (70° C. or | | | |
| less) | | | |
| Weight (g) | 0.75 | 0.92 | — |
| Hardness (Hv) | 120~180 | 240~290 | — |
| Components | 100 parts by | 100 parts by | 100 parts by |
| | weight of iron | weight of iron | weight of iron |
| | (Fe) | (Fe) | (Fe) |
| | 250 parts by | 17.8 parts by | 22.5 parts by |
| | weight of | weight of nickel | weight of chrome |
| | Copper (Cu) | (Ni) | (Cr) |
| | 7.1 parts by | 19.2 parts by | |
| | weight of Tin | weight of chrome | |
| | (Sn) | (Cr) | |

In the case of Inventive Example 1 in which the sleeve is formed of the SUS powder sintered body containing the SUS 304, it may be appreciated from Table 1 that the surface porosity is 20 to 50%, while the oil content ratio is 6 to 10%.

On the other hand, in the case of the Comparative Example in which the sleeve is formed of the sintered body containing the alloy of Cu and Fe, it may be appreciated that the surface porosity is 10 to 20%, while the oil content ratio is 5 to 9%.

When the surface porosities in the Inventive Example 1 and the Comparative Example are compared with each other, it may be appreciated that the oil is barely impregnated in the sleeve 40 according to Inventive Example 1.

That is, the inner pores 48 of the sleeve 40 according to Inventive Example 1 may be called closed pores keeping the oil from flowing between one surface and the other surface of the sleeve in the diameter direction thereof.

Therefore, the porous hydrodynamic bearing according to an embodiment of the present invention includes the sleeve formed of the SUS series or iron (Fe) powder sintered body, such that the surface pores and the inner pores are not in communication with each other, whereby a leakage phenomenon of the dynamic pressure may be reduced, as compared to the sleeve made of the alloy of Cu and Fe in which opened pores are formed.

FIG. 3 is a graph illustrating stress-strain curves of Inventive Examples and Comparative Example according to the present invention.

Referring to FIG. 3, the stress-strain curves of the Inventive Examples and the Comparative Example according to the present invention are shown. It may be appreciated from FIG. 3 that the strains due to the stress in the Inventive Examples 1 and 2 are smaller than the strain due to the stress in the Comparative Example.

That is, it may be appreciated that the sleeve manufactured according to the Inventive Examples of the present invention has more excellent impact resistance, as compared to the sleeve manufactured according to the Comparative Example.

With respect to the above-mentioned opened and closed pores, a method of calculating opened and closed porosities may be obtained from the following Equation.

$$[ Opened Porosity Calculating Equation ]$$

$$Opened Porosity ( vol . \% ) = \frac{{V}_{theory} - {V}_{Pycnomet}}{{V}_{theory}} \times 100 \\ [ Closed Porosity Calculating Equation ]$$

$$Closed Porosity ( vol . \% ) = \frac{{V}_{Pycnomet} - ( \frac{{W}_{measure}}{{ρ}_{theory}} )}{{V}_{theory}} \times 100$$

Here, V_{theory} indicates a theoretical volume [cm³], V_{Pycnomet} indicates a bulk volume [cm³] measured by a pycnometer, Wₘₑₐₛᵤᵣₑ indicates a measured weight [g], and P_{theory} indicates a theoretical density [g/cm³].

Calculation results of opened porosity, closed porosity, and the oil content ratio in the Inventive Example of the present invention, in which the sleeve is formed of the SUS powder sintered body containing the SUS 304, according to the above-mentioned Equation is given by the following Table 2.

In the oil used at the time of the measurement of the oil content ratio, a specific gravity was 0.875, kinematic viscosity at a temperature of 40° C. was 65 centistokes (cSt), and kinematic viscosity at a temperature of 100° C. was 8.8 cSt.

TABLE 2

| SUS 304 L | 1 | 2 |
|---|---|---|
| Opened Porosity | 19.96 | 20.06 |
| (vol. %) | | |
| Closed Porosity | 7.25 | 7.00 |
| (vol. %) | | |
| Oil Content Ratio (%) | 12.57 | 17.38 |

As set forth above, with the porous hydrodynamic bearing according to the embodiments of the present invention, the sleeve is formed of the SUS series or iron (Fe) powder sintered body, whereby a groove structure such as the dynamic pressure groove or the oil escape groove may be easily formed in the surface of the sleeve through electrolytic machining.

In addition, in the sleeve formed of the SUS series or iron (Fe) powder sintered body, the surface pores and the inner pores are not in communication with each other, whereby the leakage phenomenon of the dynamic pressure may be reduced, as compared to the sleeve made of the alloy of Cu and Fe in which opened pores are formed.

Further, the sleeve formed of the SUS series or iron (Fe) powder sintered body has superior corrosion resistance than the sleeve made of the alloy of Cu and Fe.

Furthermore, a process of immersing the sintered sleeve in the resin, or the like, that is required in order to fill the pores thereof with the resin at the time of manufacturing of the sintered sleeve made of the mixture of Cu and Fe may be reduced, whereby productivity may be increased and manufacturing costs may be reduced.

While the present invention has been shown and described in connection with the embodiments, it will be apparent to those in the art that modifications and variations can be made without departing from the spirit and scope of the invention as defined by the appended claims. Accordingly, various substitutions, modifications and alterations may be made within the scope of the present invention may be made by those skilled in the art without departing from the spirit of the prevent invention defined by the accompanying claims.

What is claimed is:

1. A porous hydrodynamic bearing comprising a sleeve supporting a shaft, the sleeve being formed of a sintered body containing at least one metal powder selected from a group consisting of steel use stainless (SUS) series including SUS 304, SUS 430 or the like, and iron (Fe).

2. The porous hydrodynamic bearing of claim 1, wherein the sleeve includes a hydrodynamic groove formed through a sintering process and has surface porosity of 20 to 50%.

3. The porous hydrodynamic bearing of claim 2, wherein the hydrodynamic groove is formed through electrolytic machining.

4. The porous hydrodynamic bearing of claim 1, wherein the sleeve includes a groove formed through electrolytic machining.

5. The porous hydrodynamic bearing of claim 1, wherein the sintered body has an oil content ratio of 6 to 20%.

6. The porous hydrodynamic bearing of claim 1, wherein the SUS 304 includes 100 parts by weight of iron (Fe), 11 to 28 parts by weight of nickel (Ni), and 16 to 38 parts by weight of chrome (Cr).

7. The porous hydrodynamic bearing of claim 6, wherein the SUS 304 further includes at least one impurity selected from a group consisting of carbon (C), oxygen (O), silicon (Si), manganese (Mn), phosphorus (P), and sulfur (S).

8. The porous hydrodynamic bearing of claim 1, wherein pores formed in the sleeve are closed pores keeping oil from flowing between one surface and the other surface of the sleeve in the diameter direction thereof.
